(19) United States
(12) Patent Application Publication
(10) Pub. No.: US 2007/0053066 A1
(43) Pub. Date: Mar. 8, 2007

(54) Device for homogenizing light and configuration for illuminating or focusing with such a device

(75) Inventor: Thomas Mitra, Dortmund (DE)

Correspondence Address: LERNER GREENBERG STEMER LLP, P O BOX 2480, HOLLYWOOD, FL, 33022-2480, US

(73) Assignee: Hentze-Lissotschenko Patentverwaltungs GmbH & Co. KG

(21) Appl. No.: 11/516,475

(22) Filed: Sep. 6, 2006

Related U.S. Application Data
(63) Continuation of application No. PCT/EP04/08944, filed on Aug. 10, 2004.
(63) Continuation of application No. PCT/EP04/09325, filed on Aug. 20, 2004.

(30) Foreign Application Priority Data
Mar. 6, 2004 (DE) 10 2004 011 074.3
Jul. 14, 2004 (DE) 10 2004 034 253.9

(51) Int. Cl. G02B 27/10

(52) U.S. Cl. 359/623

(57) ABSTRACT

A device for homogenizing light contains at least one homogenizer device having an entrance surface and an exit surface for the light that is to be homogenized. An array of cylinder lenses is disposed on the input surface and an array of cylinder lenses is disposed on the output surface of the at least one homogenizer. Cylinder axes of the cylinder lenses of the at least one homogenizer are oriented in a parallel manner in relation to each other. A configuration for illuminating a surface and to a configuration for focussing the light from a laser light source into a linear focussing area use the device for homogenizing.

### CROSS-REFERENCE TO RELATED APPLICATIONS

This is a continuing application, under 35 U.S.C. §120, of copending international application PCT/EP2004/009325, filed Aug. 20, 2004, which designated the United States; this application also claims the priority, under 35 U.S.C. §119, of German patent applications DE 10 2004 011 074.3, filed Mar. 6, 2004 and DE 10 2004 034 253.9, filed Jul. 14, 2004; this application further claims the priority of international application PCT/EP2004/008944, filed Aug. 10, 2004; the prior applications are herewith incorporated by reference in their entirety.

### BACKGROUND OF THE INVENTION

### Field of the Invention

The present invention relates to a device for homogenizing light which contains at least one homogenizing device having an entrance surface and an exit surface for the light to be homogenized. In each case an array of cylindrical lenses on the entrance surface or in the vicinity of the entrance surface, and an array of cylindrical lenses on the exit surface or in the vicinity of the exit surface of the at least one homogenizing device are provided. A configuration for illuminating a surface and a configuration for focusing the light from a laser light source into a linear region of focus are also discussed.

A device of the abovenamed type is disclosed in U.S. Pat. No. 4,733,944. The device for homogenizing that is described therein contains two homogenizing devices spaced apart from one another, each of the homogenizing devices contain two optically functional boundary surfaces through which the light to be homogenized passes. An array of cylindrical lenses is respectively disposed on each of these four boundary surfaces that contribute to homogenization. In this case, each of the two homogenizing devices spaced apart from one another has two arrays of mutually crossed cylindrical lenses. For example, in the case of one of the homogenizing devices a cylindrical lens array having cylinder axes in the vertical is constructed on an entrance surface, and a cylindrical lens array having cylinder axes in the horizontal is constructed on the exit surface.

Thus, such a device for homogenizing can be used to homogenize a laser beam, such as, for example, a beam emanating from an excimer laser or a laser beam emanating from a laser diode bar, both in a first direction and in a second direction perpendicular thereto. For example, in the case of a laser diode bar, such a device for homogenizing can be used to produce a homogenization both on the so-called fast axis and on the so-called slow axis. Furthermore, the abovenamed device known from the prior art is configured as a so-called two-stage device for homogenizing, because the beam to be homogenized experiences the homogenization in each of the homogenizers. A substantially better homogeneity is achieved by the two-stage configuration of the device over a one single-stage homogenizer.

In the case of such two-stage devices for homogenizing known from the prior art, the adjustment of the two homogenizing devices is decidedly difficult to carry out, proves, however, to be disadvantageous. The homogenizing devices must be positioned very accurately relative to one another, each of the homogenizing devices requiring to be adjusted exactly with reference to six axes overall. Furthermore, the focal lengths of the cylindrical lenses of the array are not freely selectable, since an optimum spacing of the cylindrical lenses relative to one another is given for each of the two directions that can be homogenized independently of one another, for example the slow axis and the fast axis. In particular, two-stage devices for homogenizing that operate in the two directions independent of one another react very sensitively to focal length errors of the cylindrical lenses, since the two directions are not independent of one another, as a rule.

### SUMMARY OF THE INVENTION

It is accordingly an object of the invention to provide a device for homogenizing light and a configuration for illuminating or focusing with such a device which overcomes the above-mentioned disadvantages of the prior art methods and devices of this general type, which can be adjusted easily. Furthermore, the aim is to specify a configuration for illuminating a surface, and a configuration for focusing the light from a laser light source into a linear region of focus.

With the foregoing and other objects in view there is provided, in accordance with the invention, a device for homogenizing light. The device contains at least one homogenizer device having an entrance surface and an exit surface for the light to be homogenized, a first array of cylindrical lenses disposed on the entrance surface or in a vicinity of the entrance surface, and a second array of cylindrical lenses disposed on the exit surface or in a vicinity of the exit surface. The cylindrical lenses of the first and second arrays have cylinder axes aligned parallel to one another.

It is provided that the cylinder axes of the cylindrical lenses of the at least one homogenizing device are aligned parallel to one another. The at least one homogenizing device, configured, for example, as a substrate, therefore fulfills the function of a two-stage homogenizer. For example, in the case of the homogenization of the laser light emanating from a laser diode bar, it follows that the homogenizing device acts on one axis or one direction, that is to say only on the slow axis or only on the fast axis, for example.

In accordance with a further embodiment of the invention, the possibility exists that the device contains a first homogenizer device and a second homogenizer device that in each case have an entrance surface and an exit surface for the light to be homogenized. It can be provided in this case that the first homogenizer device respectively has an array of cylindrical lenses on the entrance surface or in the vicinity of the entrance surface, and an array of cylindrical lenses on the exit surface or in the vicinity of the exit surface, the cylinder axes of which are aligned parallel to one another.

It can be provided in another embodiment of the invention that the second homogenizer device has an array of cylindrical lenses on the entrance surface or in the vicinity of the entrance surface, or an array of cylindrical lenses on the exit surface or in the vicinity of the exit surface.

Alternatively, it can be provided that the second homogenizer device respectively has an array of cylindrical lenses on the entrance surface or in the vicinity of the entrance surface, and an array of cylindrical lenses on the exit surface or in the vicinity of the exit surface, the cylinder axes of which are aligned parallel to one another.

In particular, it can be provided that the cylinder axes of the cylindrical lenses of the first homogenizer device are aligned perpendicular to the cylinder axes of the cylindrical lenses of the second homogenizer device. In this way, the two directions or axes of the laser light are homogenized separately from one another in the two homogenizer devices, which are, in particular, spaced apart from one another. The two homogenizer devices need no longer be adjusted relative to one another, because the adjustment of the cylindrical lenses, which act for example on one of the two axes, is achieved by the fabrication of the homogenizer device, which can be reproduced at any time within the manufacturing tolerances. In this way, the beam properties are always the same within the constraints of the abovenamed manufacturing tolerances. Furthermore, the two axes such as, for example, the slow axis and the fast axis in the case of a semiconductor laser bar are not subjected to an influence by focal length tolerances of the respective other beam axis. Furthermore, it is possible when homogenizing the laser light with regard to the two axes to select the focal lengths of the cylindrical lenses freely for each of the axes and independently of the respective other axis.

In accordance with an added embodiment of the invention, the focal planes of the cylindrical lenses disposed on the exit surface or in the vicinity of the exit surface are disposed in the entrance surface or in the vicinity of the entrance surface. The homogenization of the light to be homogenized is optimized in this way.

It can be provided that the cylindrical lenses are configured as concave and/or convex lenses or as GRIN lenses (gradient index lenses).

It is provided that the device used in the configuration is an inventive device for homogenizing.

It is provided in accordance with another embodiment of the invention, that the device used in the configuration for focusing likewise is an inventive device for homogenizing.

It can be provided in this case that the device for homogenizing is fashioned in such a way that it homogenizes the laser light only with regard to the slow axis direction.

Other features which are considered as characteristic for the invention are set forth in the appended claims.

Although the invention is illustrated and described herein as embodied in a device for homogenizing light and a configuration for illuminating or focusing with such a device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, plan view of a configuration for illuminating according to the invention;

FIG. 1B is a diagrammatic, side view of the configuration in accordance with FIG. 1A;

FIG. 2A is a diagrammatic, plan view of a configuration for focusing according to the invention;

FIG. 2B is a diagrammatic, side view of the configuration for focusing in accordance with FIG. 2A; and

FIG. 3 is a diagrammatic, perspective view of a device according to the invention.

### DESCRIPTION OF THE PREFERRED EMBODIMENTS

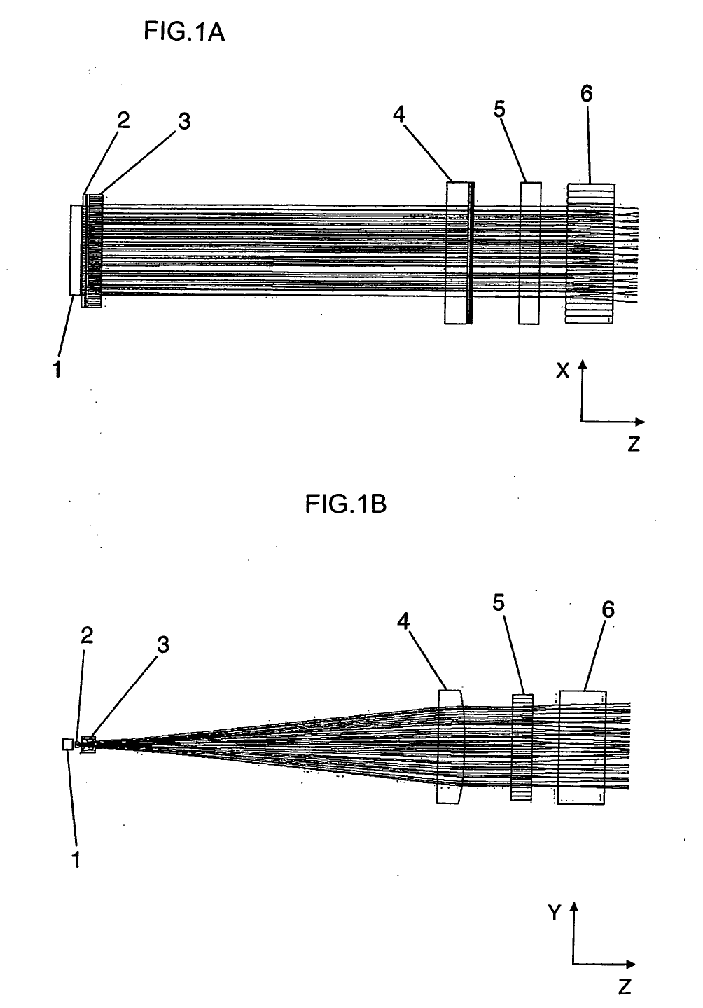

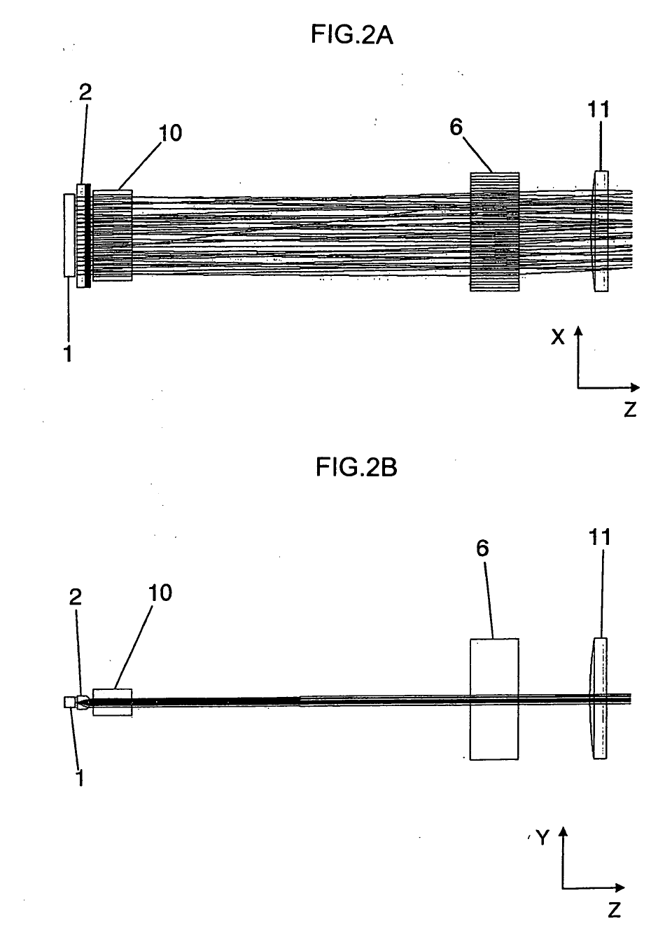

Cartesian coordinate systems have been drawn in in some of the figures in order to improve clarity. Referring now to the figures of the drawing in detail and first, particularly, to FIGS. 1A-1B thereof, there is shown an inventive configuration for a semiconductor laser bar 1 that has a number of emitters disposed next to one another in the X direction and spaced apart from one another. The semiconductor laser bar 1 is illustrated in FIG. 1A, FIG. 1B, FIG. 2A and FIG. 2B solely schematically by a rectangle. In the case of semiconductor laser bars, the divergence in the so-called fast axis, that is to say in the Y direction or in the direction perpendicular to the direction in which the emitters are disposed next to one another, is clearly greater than in the so-called slow axis or the X direction.

It is to be seen from FIG. 1A and FIG. 1B that a fast axis collimation device 2 adjoins the semiconductor laser bar 1 in a propagation direction Z of the laser light emerging from the individual emitters of the semiconductor laser bar 1. The fast axis collimation device 2 is configured, for example, as a plano-convex cylindrical lens whose cylinder axis extends in the X direction. Such a cylindrical lens can be used to collimate the laser light emerging from the individual emitters with regard to the Y direction or with regard to the fast axis, doing so with limited diffraction. In order to achieve this, the cylindrical lens serving as the fast axis collimation device 2 can have an aspheric surface. Instead of the cylindrical lens illustrated, which has a convex curvature only on its exit fashion, a cylindrical lens with a convexly curved entrance side can also be used. As an alternative thereto, it is also possible for both the entrance side and the exit side to be convexly and/or concavely curved.

Adjoining the fast axis collimation device 2 in the propagation direction Z is a beam transformation device 3. The incident light is rotated by an angle of 90° in the beam transformation device 3, or the divergence of the fast axis (Y direction) is exchanged for that of the slow axis (X direction) such that after the exit from the beam transformation device 3 the divergence in the Y direction is larger than the divergence in the X direction.

The beam transformation device 3 can be a substantially cuboid block made from a transparent material on which a number of cylindrical lens segments serving as beam transformation elements are disposed parallel to one another both on the entrance side and on the exit side. The axes of the beam transformation elements can enclose an angle α of 45′ in this case with the base side of the cuboid beam transformation device 3, which runs in the X direction.

A further collimation device 4 adjoins the beam transformation device 3 in the propagation direction Z of the laser light such that, for example, a beam of 10 mm×10 mm with a divergence of approximately 11 mrad in the Y direction and a divergence of approximately 3 mrad in the X direction can be achieved. The numerical values for divergence and beam diameter relate to the full width of the beam at half the maximum intensity (FWHM). The collimation device 4 is configured as a plano-convex cylindrical lens having a cylinder axis extending in the X direction. Because of the rotation of the laser light in the beam transformation device 3, the collimation device 4 therefore has the same alignment as the fast axis collimation device 2. In the same way as the fast axis collimation device 2, it is also possible for the collimation device 4 to be fashioned differently. In particular, both entrance surface and exit surface can be provided with a convex and/or concave curvature.

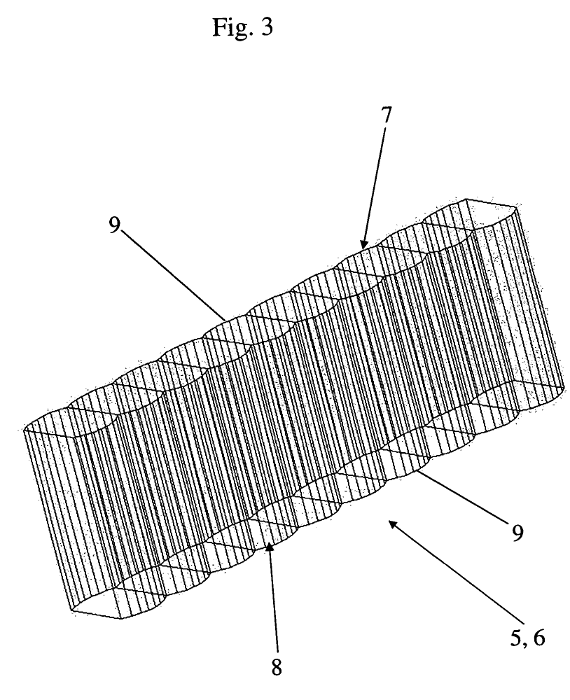

Adjoining the collimation device 4 in the propagation direction Z is a first homogenizer or homogenizing device 5 and a second homogenizer or homogenizing device 6 adjoining the former. On their entrance surface 7, the homogenizing device 5 has an array of cylindrical lenses 9 whose cylinder axes extend in the X direction (see also FIG. 3 in this regard). Furthermore, on their exit surface 8 the first homogenizing device 5 has an array of cylinder lenses 9 whose cylinder axes likewise extend in the X direction. The laser light passing through the first homogenizing device 5 is superimposed with one another very effectively in the Y direction by the cylindrical lens arrays 9 on the entrance and exit surfaces 7, 8 of the first homogenizing device 5. It is possible to homogenize the laser light in the Y direction by this effective superimposition, which is illustrated from FIG. 1B by the regions of focus visible downstream of the first homogenizing device 5.

The configuration contains a second homogenizing device 6 downstream of the first homogenizing device 5 in the beam propagation direction Z. On their entrance surface 7 and on their exit surface 8, the second homogenizing device 6 respectively has a cylindrical lens array having cylindrical lenses 9 that extend in the Y direction (see also FIG. 3 in this regard). The laser light passing through the second homogenizing device 6 is superimposed on one another very effectively in the X direction by the cylindrical lens arrays 9 on the entrance and exit surfaces 7, 8 of the second homogenizing device 6. The laser light can be homogenized in the X direction by this effective superimposition, which is illustrated in FIG. 1A by the regions of focus to be seen downstream of the second homogenizing device 6.

The device for homogenizing in this case contains the first and the second homogenizing devices 5, 6. Overall, the laser light is thus homogenized in two directions or axes in the inventive device, the second stage acting only on the X direction, and the first stage only on the Y direction.

The cylindrical lenses 9 of the homogenizing devices 5, 6 can be configured as convex (see FIG. 3 by way of example) and/or as concave cylindrical lenses. It is possible as an alternative to this to configure the cylindrical lenses as GRIN lenses (gradient index lenses). The cylindrical lenses are disposed in this case not on the entrance or exit surfaces but instead are formed in the vicinity of the entrance or exit surfaces in the interior of the substrate respectively forming the homogenizing devices 5, 6 by a varying refractive index of the substrate.

The laser light emerges from the second homogenizing device 6 in a fashion homogenized to the greatest extent, and can be used to illuminate a surface remote from the device.

The embodiment, depicted in FIG. 2A and FIG. 2B, of an inventive configuration likewise contains a semiconductor laser bar 1 having a plurality of emitters.

The configuration further contains the fast axis collimation device 2 that can be configured like the fast axis collimation device 2 in accordance with FIG. 1A and FIG. 1B. It can be provided in this case to select the distance between the semiconductor laser and the fast axis collimation device 2 to be comparatively large such that the laser light in the Y direction has a comparatively large extent after the passage through the fast axis collimation device 2.

In the beam direction downstream of the fast axis collimation device 2, the inventive configuration contains a slow axis collimation device 10 that is configured in the exemplary embodiment depicted as an array of cylindrical lenses on the entrance and on the exit sides of the slow axis collimation device 10. The cylinder axes of the cylindrical lenses of the slow axis collimation device 10 extend in this case in the Y direction. In particular, the slow axis collimation device can be disposed in such a way that one of the partial beams of the laser light that emanate from in each case one of the emitters enters each of the cylindrical lenses on the entrance side. Each of the partial beams is collimated by the corresponding cylindrical lenses with regard to the slow axis or with regard to the X direction.

The embodiment of the slow axis collimation device 10 depicted in FIG. 2A and FIG. 2B constitutes a telescope configuration. However, it is also possible to configure the slow axis collimation device 10 as an array of cylindrical lenses that is disposed only on one side, for example the entrance side or the exit side. It is further possible to use more than two optically functional, in particular curved surfaces resembling cylindrical lenses for the slow axis collimation device 10.

The embodiment, depicted in FIG. 2A and FIG. 2B, of the inventive configuration further contains the second homogenizing device 6 downstream of the slow axis collimation device 10 in the propagation direction. The homogenizing device 6 corresponds with regard to its configuration exactly to the second homogenizing device 6 of the configuration in accordance with FIG. 1A and FIG. 1B. The axes of the cylindrical lenses 9 on the entrance surface 7 and the exit surface 8 extend in this case in the Y direction such that the cylindrical lenses 9 influence the laser radiation 3 only with regard to the slow axis direction.

Owing to the passage through the cylindrical lenses 9 of the homogenizing device 6, the individual partial beams of the laser light are very effectively superimposed on one another in the slow axis direction or in the X direction. The laser light emerging from the homogenizing device 6 can be focused by a focusing device 11 disposed downstream of the homogenizing device 6 in the propagation direction Z. In the exemplary embodiment depicted, the focusing device 11 is configured as a rotationally symmetrical plano-convex lens. The focusing device 11 can also be formed by other configurations, for example by a biconvex lens or by a number of cooperating lenses. This lens can focus the laser radiation 10 with regard to the fast axis or the Y direction, and serve at the same time as field lens for the homogenizing device 6 acting only on the slow axis or X direction. It is possible here in practice for the focus of the lens serving as the focusing device 11 to lie with regard to the fast axis in a plane in which the field of the laser light is homogenized in the slow axis direction by the lens acting as field lens.

The laser radiation that has passed through the homogenizing device 10 is illustrated in FIG. 2A and FIG. 2B only in an unstructured fashion. However, each of the cylindrical lenses 9 refracts the light that has passed through them into a multiplicity of different directions. The plano-convex spherical lens serving as the focusing device 11 or field lens deflects every partial beam, impinging on the field lens at the same angle, in a linear region of focus onto the same point such that the components of the laser light stemming from individual partial beams of the original laser light are distributed uniformly in the region of focus over the width thereof in the X direction or in the slow axis direction.

The focusing device 11 focus the laser light into a linear region of focus that extends in the X direction and has a very slight extent in the Y direction. It is possible, for example, for the extent of the region of focus to be smaller than 1 mm, or smaller than 0.5 mm, in the Y direction or in the fast axis direction. It is possible, moreover, for the width of the linear region of focus to be larger than 5 mm or larger than 20 mm in the X direction or in the slow axis direction. The distance d between the exit surface of the focusing device 11 and the linear region of focus can be comparatively large, for example larger than 50, in particular larger than 200 mm.

I claim:

1. A device for homogenizing light, comprising:
at least one homogenizer device having an entrance surface and an exit surface for the light to be homogenized;
a first array of cylindrical lenses disposed one of on said entrance surface and in a vicinity of said entrance surface; and
a second array of cylindrical lenses disposed one of on said exit surface and in a vicinity of said exit surface, said cylindrical lenses of said first and second arrays having cylinder axes aligned parallel to one another.

2. The device according to claim 1, wherein said at least one homogenizer device includes a first homogenizer device and a second homogenizer device that in each case have said entrance surface and said exit surface for the light to be homogenized.

3. The device according to claim 2, wherein:
said first homogenizer device has said first array of cylindrical lenses disposed one of on said entrance surface and in a vicinity of said entrance surface of said first homogenizer device; and
said first homogenizer device has said second array of cylindrical lenses disposed one of on said exit surface and in a vicinity of said exit surface of said first homogenizer device, said cylinder axes of said cylindrical lenses of said first and second arrays of said first homogenizer device are aligned parallel to one another.

4. The device according to claim 3, wherein said second homogenizer device has said first array of cylindrical lenses disposed one of on said entrance surface and in a vicinity of said entrance surface of said second homogenizer device.

5. The device according to claim 3, wherein:
said second homogenizer device has said first array of cylindrical lenses disposed one of on said entrance surface and in a vicinity of said entrance surface of said second homogenizer device; and
said second homogenizer device has said second array of cylindrical lenses disposed one of on said exit surface and in a vicinity of said exit surface of said second homogenizer device, said cylinder axes of said cylindrical lenses of said first and second arrays of said second homogenizer device are aligned parallel to one another.

6. The device according to claim 4, wherein said cylinder axes of said cylindrical lenses of said first homogenizer device are aligned perpendicular to said cylinder axes of said cylindrical lenses of said second homogenizer device.

7. The device according to claim 1, wherein said cylindrical lenses of said second array having focal planes disposed in said entrance surface or in a vicinity of said entrance surface.

8. The device according to claim 1, wherein said cylindrical lenses are selected from the group consisting of concave lenses, convex lenses and gradient index lenses.

9. The device according to claim 5, wherein said cylinder axes of said cylindrical lenses of said first homogenizer device are aligned perpendicular to said cylinder axes of said cylindrical lenses of said second homogenizer device.

10. The device according to claim 3, wherein said second homogenizer device has said second array of cylindrical lenses disposed one of on said exit surface and in a vicinity of said exit surface of said second homogenizer device.

11. The device according to claim 10, wherein said cylinder axes of said cylindrical lenses of said first homogenizer device are aligned perpendicular to said cylinder axes of said cylindrical lenses of said second homogenizer device.

12. A configuration for illuminating a surface, the configuration comprising:
at least one semiconductor laser bar having a plurality of emitters disposed in a first direction next to one another, at a spacing from one another and emitting a laser light, a divergence of the laser light emerging from individual ones of said emitters being smaller with regard to the first direction than a divergence of the laser light with regard to a second direction being perpendicular to the first direction;
a collimator disposed downstream of said semiconductor laser bar for at least partial collimation of the laser light emerging from said emitters;
a beam transformation device disposed downstream of said collimator for transforming the laser light emerging from said emitters, said beam transformation device configured and disposed in a beam path of the laser light emerging from said emitters for exchanging a divergence of the laser light with regard to the first direction for a divergence with regard to the second direction; and
a device for homogenizing the laser light emerging from said emitters, said device for homogenizing including:
at least one homogenizer device having an entrance surface and an exit surface for the laser light to be homogenized;
a first array of cylindrical lenses disposed one of on said entrance surface and in a vicinity of said entrance surface; and
a second array of cylindrical lenses disposed one of on said exit surface and in a vicinity of said exit surface, said cylindrical lenses of said first and second arrays having cylinder axes aligned parallel to one another.

13. The configuration for illuminating the surface according to claim 12, wherein said device for homogenizing is of a multistage configuration.

14. The configuration for illuminating the surface according to claim 12, wherein said collimator has a fast axis collimation device for collimating the laser light emerging from said emitters with regard to the second direction.

15. The configuration for illuminating the surface according to claim 12, wherein said collimator includes a collimation device collimating the laser light emerging from said emitters with regard to the first direction.

16. A configuration for focusing light from a laser light source into a linear region of focus, the configuration comprising:
at least one semiconductor laser bar having at least one emitting section and outputting a laser light, a divergence of the laser light emanating from said at least one emitting section being larger in a fast axis direction than in a slow axis direction being perpendicular to the fast axis direction;
a fast axis collimation device disposed downstream of said semiconductor laser bar for collimating the laser light emerging from said at least one emitting section with regard to the fast axis direction;
a device for homogenizing the laser light collimated by said fast axis collimation device and disposed downstream of said fast axis collimation device, said device for homogenizing, including:
at least one homogenizer device having an entrance surface and an exit surface for the laser light to be homogenized;
a first array of cylindrical lenses disposed one of on said entrance surface and in a vicinity of said entrance surface; and
a second array of cylindrical lenses disposed one of on said exit surface and in a vicinity of said exit surface, said cylindrical lenses of said first and second arrays having cylinder axes aligned parallel to one another; and
a focusing device disposed downstream of said device for homogenizing, said focusing device focusing the laser light emanating from the device for homogenizing into the linear region of focus.

17. The configuration for focusing according to claim 16, wherein said device for homogenizing homogenizes the laser light only with regard to the slow axis direction.

18. The configuration for focusing according to claim 16, further comprising a slow axis collimation device disposed between said fast axis collimation device and said device for homogenizing.

19. The configuration for focusing according to claim 18, wherein said slow axis collimation device is a device selected from the group consisting of a slow axis collimator array and a slow axis telescope array.

20. The configuration for focusing according to claim 16, wherein said focusing device contains at least one substantially rotationally symmetrical lens, said lens serving as a field lens for said device for homogenizing in the slow axis direction.
